(19) United States
(12) Patent Application Publication
(10) Pub. No.: US 2026/0162317 A1
(43) Pub. Date: Jun. 11, 2026

(54) FOVEATED RENDERING UNDER DIFFERENT LIGHT CONDITIONS

(71) Applicant: Microsoft Technology Licensing, LLC, Redmond, WA (US)

(72) Inventors: Michael BLEYER, Seattle, WA (US); Pascal PARÉ, Bothell, WA (US); Christian Markus MAEKELAE, Monroe, WA (US); Christopher Douglas EDMONDS, Carnation, WA (US)

(21) Appl. No.: 18/975,965

(22) Filed: Dec. 10, 2024

(51) Int. Cl. G06T 11/00; G06F 3/01; G06T 3/40; G06T 7/11; G06T 7/33

(52) U.S. Cl. CPC G06T 11/00; G06F 3/013; G06T 3/40; G06T 7/11; G06T 7/337; G06T 2200/24; G06T 2207/20016; G06T 2207/20104; G06T 2207/20132; G06T 2210/22; G06T 2210/36

(57) ABSTRACT

Techniques for performing foveated rendering are disclosed. A service accesses an original image of a scene. The service creates a binned image by down-sampling the original image. The service creates an un-binned image by cropping the original image. The service performs an image processing operation on the binned and/or the un-binned images. The service creates an up-sampled image by up-sampling the binned image. The service creates a cropped image by cropping the up-sampled image. Based on a light parameter of the scene, the service imposes a biasing function that biases an incorporation of pixels from one or both of the un-binned image and the cropped image, resulting in generation of a biased image. The service generates a foveated image by overlaying and aligning the biased image onto the up-sampled image.

### BACKGROUND

Head mounted devices (HMDs), or other wearable devices, are becoming highly popular. These types of devices are able to provide a so-called “extended reality” experience.

The phrase “extended reality” (ER) is an umbrella term that collectively describes various different types of immersive platforms. Such immersive platforms include virtual reality (VR) platforms, mixed reality (MR) platforms, and augmented reality (AR) platforms. The ER system provides a “scene” to a user. As used herein, the term “scene” generally refers to any simulated environment (e.g., three-dimensional (3D) or two-dimensional (2D)) that is displayed by an ER system.

For reference, conventional VR systems create completely immersive experiences by restricting their users' views to only virtual environments. This is often achieved through the use of an HMD that completely blocks any view of the real world. Conventional AR systems create an augmented-reality experience by visually presenting virtual objects that are placed in the real world. Conventional MR systems also create an augmented-reality experience by visually presenting virtual objects that are placed in the real world, and those virtual objects are typically able to be interacted with by the user. Furthermore, virtual objects in the context of MR systems can also interact with real world objects. AR and MR platforms can also be implemented using an HMD. ER systems can also be implemented using laptops, handheld devices, HMDs, and other computing systems.

Unless stated otherwise, the descriptions herein apply equally to all types of ER systems, which include MR systems, VR systems, AR systems, and/or any other similar system capable of displaying virtual content. An ER system can be used to display various different types of information to a user. Some of that information is displayed in the form of a “hologram.” As used herein, the term “hologram” generally refers to image content that is displayed by an ER system. In some instances, the hologram can have the appearance of being a 3D object while in other instances the hologram can have the appearance of being a 2D object. In some instances, a hologram can also be implemented in the form of an image displayed to a user.

Continued advances in hardware capabilities and rendering technologies have greatly increased the realism of holograms and scenes displayed to a user within an ER environment. For example, in ER environments, a hologram can be placed within the real world in such a way as to give the impression that the hologram is part of the real world. As a user moves around within the real world, the ER environment automatically updates so that the user is provided with the proper perspective and view of the hologram. This ER environment is the “scene” mentioned previously.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system including: a processor system; and a storage system that stores instructions that are executable by the processor system to cause the computer system to: access a binned image that is a down-sampled version of an original image; access an un-binned image that is either (i) a cropped version of the original image or (ii) the original image, the un-binned image including first content; apply an image processing operation on at least one of the binned image or the un-binned image; based on a parameter, impose a biasing function that biases an incorporation of pixels originating from one or both of the un-binned image and pixels based on corresponding pixels of the binned image, resulting in generation of a biased image; and generate a foveated image by overlaying and aligning the biased image onto up-sampled pixels from the binned image.

In some aspects, the techniques described herein relate to an extended reality (ER) system including: a processor system; and a storage system that stores instructions that are executable by the processor system to cause the ER system to: access a binned image that is a down-sampled version of an original image; access an un-binned image that is either (i) a cropped version of the original image or (ii) the original image, the un-binned image including first content; based on (i) a noise parameter, (ii) a light parameter, or (iii) a camera parameter, impose a biasing function that biases an incorporation of pixels originating from one or both of the un-binned image and pixels based on corresponding pixels of the binned image, resulting in generation of a biased image; and generate a foveated image by combining the biased image with pixels based on the binned image.

In some aspects, the techniques described herein relate to a method of generating a foveated image from an original image, the foveated image comprising output pixels for a lower effective resolution portion and output pixels for a higher effective resolution portion, the method comprising: for at least the output pixels of the higher effective resolution portion of the output image, each output pixel having a corresponding coordinate: impose a biasing function, the biasing function biasing an incorporation of pixels from one or both of: (a) an un-binned pixel corresponding to the coordinate, and (b) a binned pixel corresponding to the coordinate, the binned pixel corresponding to the coordinate being a down-sampled pixel of the original image, wherein: for output pixels of the higher effective resolution portion of the foveated image, the biasing function including incorporation of the un-binned pixels; and for output pixels of the lower effective resolution portion of the foveated image, the output pixels not incorporating the un-binned pixels.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture in which the disclosed principles can be practiced.

FIG. 2 illustrates an example HMD.

FIG. 3 illustrates an example technique for performing foveated rendering.

FIG. 4 illustrates how noise can be introduced when foveated rendering is performed.

FIG. 5 illustrates an improved technique for performing foveated rendering.

FIG. 6 illustrates an example of a weight function used when performing foveated rendering.

FIGS. 7A and 7B illustrate flowcharts of example methods for performing foveated rendering.

FIG. 8 illustrates an example computer system that can be configured to perform any of the disclosed operations.

### DETAILED DESCRIPTION

The phrase “foveated rendering” (or simply “foveation”) generally refers to a process of displaying higher resolution content at a specific area in a display where a user's eyes are gazing and lower resolution content at other areas of the display, where those other areas often correspond to the user's periphery vision. In some cases, foveation can be simplified by just displaying higher resolution content at a center portion of the display. Foveation is beneficial, particularly for ER systems, because it can reduce the number of high resolution pixels that are rendered. Doing so can reduce power consumption on the ER system and can also improve performance of the ER system.

The disclosed embodiments are directed to improved techniques with regard to foveation, particularly for ER systems. Although a majority of the examples described herein are focused on the use of ER systems, one will appreciate how the disclosed principles can be employed in other scenarios as well such that these principles are not limited to scenarios only involving ER systems.

In more detail, the disclosed embodiments bring about numerous benefits, advantages, and practical applications to how images are displayed. By practicing the disclosed principles, the embodiments can reduce the battery consumption of an ER system and can also improve the efficiency by which the ER system displays content. Even further, the embodiments can improve the quality of the resulting imagery. Accordingly, these and numerous other benefits will now be described in more detail throughout the remaining portions of this disclosure.

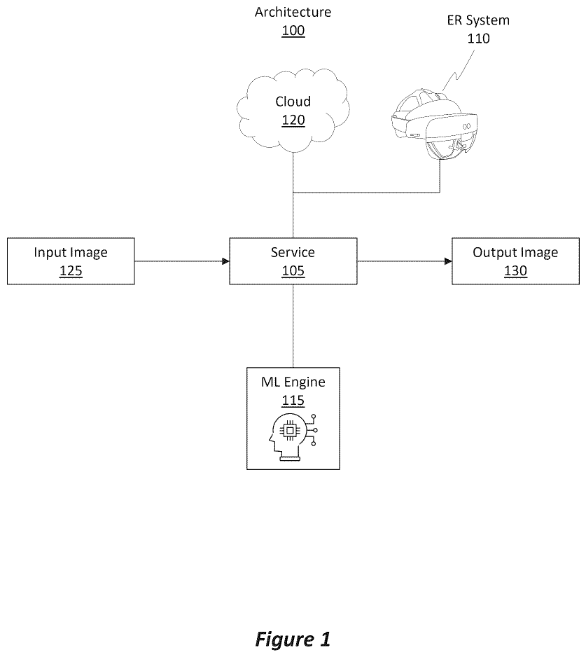

Having just described some of the high level benefits, advantages, and practical applications achieved by the disclosed embodiments, attention will now be directed to FIG. 1, which illustrates an example computing architecture 100 that can be used to achieve those benefits. Architecture 100 includes a service 105, which can be implemented by an ER system 110 comprising an HMD.

As used herein, the phrases ER system, HMD, ER platform, ER device, or wearable device can all be used interchangeably and generally refer to a type of system that displays holographic content (i.e. holograms). In some cases, ER system 110 is of a type that allows a user to see various portions of the real world and that also displays virtualized content in the form of holograms. That ability means ER system 110 is able to provide so-called “passthrough images” to the user. It is typically the case that architecture 100 is implemented on an MR or AR system, though it can also be implemented in a VR system.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 120 environment. In some implementations, service 105 is a local service operating on a local device, such as the ER system 110. In some implementations, service 105 is a hybrid service that includes a cloud component operating in the cloud 120 and a local component operating on a local device. These two components can communicate with one another.

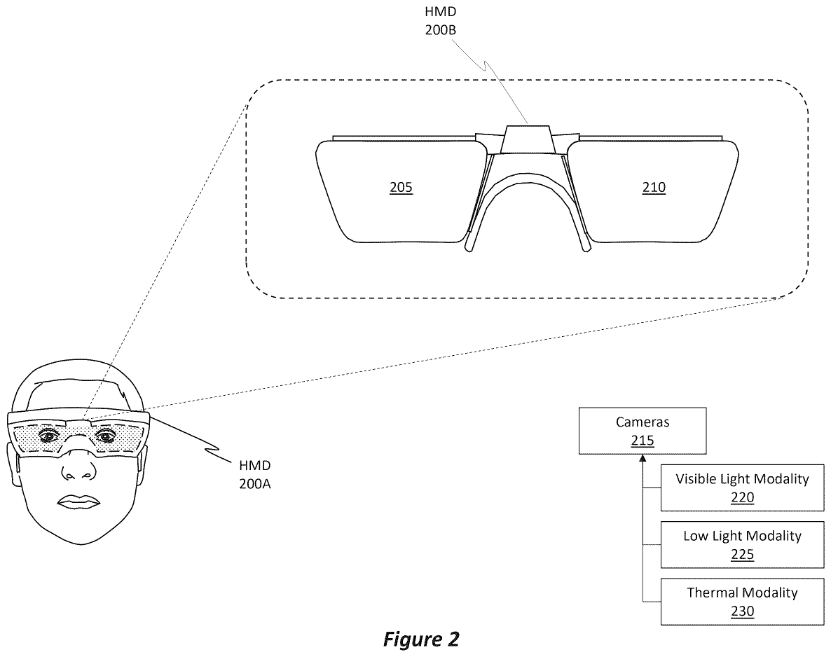

Turning briefly to FIG. 2, HMDs 200A and 200B are shown, where these HMDs are representative of the ER system 110 of FIG. 1. HMD 200B includes a left display 205, which is visible to the user's left eye, and a right display 210, which is visible to the user's right eye. Together, these two displays can provide binocular vision to the user.

By displaying holograms at specific pixel positions relative to one another, HMD 200B can display content in a manner such that the user perceives the content as having depth relative to the user. That is, HMD 200B displays a first image in the left display 205 and a second, different (though related) image in the right display 210. The user will view these two separate images, and the user's mind can fuse them, thereby allowing the user to perceive depth with respect to the holograms. As will be discussed in more detail shortly, HMD 200B is configured to provide foveated rendering and display of virtual content. It should also be noted how HMD 200B can include any number of cameras 215 of different modalities, such as a visible light modality 220, a low light modality 225, and a thermal modality 230, to name a few.

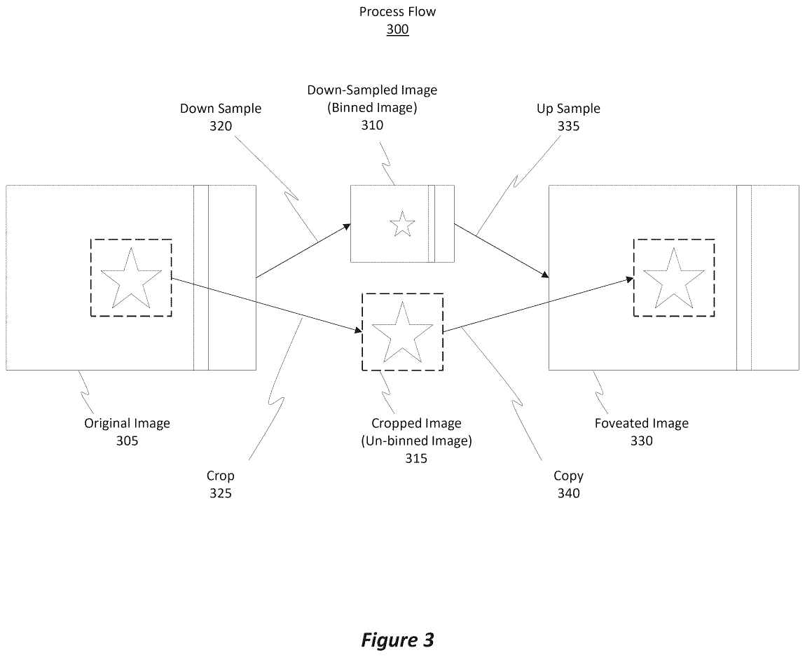

Returning to FIG. 1, service 105 is tasked with obtaining an input image 125 and generating an improved output image 130 having foveation properties. In particular, service 105 applies foveation in the ER system 110 to reduce the compute costs in the image quality enhancement pipeline, particularly for low light cameras. The enhancement pipeline can include any number of operations, such as temporal filtering operations, content enhancement operations, other types of filtering, and so on, without limit. FIG. 3 illustrates an initial approach to foveated rendering, as represented by the process flow 300.

In this initial approach to foveated rendering, an ER system accesses an original image 305. The ER system then generates two images from the original input image 305, as shown by down-sampled image (i.e. a “binned” image) 310 and cropped image (i.e. an “un-binned” image) 315. The down-sampled image is obtained by down-sampling the original image 305, as shown by the down sample 320 operation. The cropped image 315 is obtained by cropping a specific portion from the original image 305, as shown by the crop 325 operation; the content that is not discarded during the cropping operation is included in the cropped image 315. In the example shown in FIG. 3, the cropped image 315 includes the star content (i.e. the content displayed in a center region of the original image 305) while the outer portions, or peripheral portions of the original image 305 were discarded as a part of the cropping action.

The down-sampled image 310 is a low-resolution (or at least lower resolution) version of the original image 305. In at least some implementations, a pixel in the low-resolution image is obtained by binning (e.g., averaging) 2×2 pixels of the original image 305. The down-sampled image 310 can also be referred to as a “binned image.” This example focused on a scenario where 2×2 pixels were binned, but one will appreciate how any number of pixels can be binned as a part of this process. For example, creation of the down-sampled image 310 may also occur via other resampling techniques (e.g., bicubic, bilinear, adaptive, Lanczos, fant, nearest neighbor, etc.) and with other quantities of source pixels for each down-sampled pixel, including non-integer quantities.

In this example, the cropped image 315 is a crop of the center of the original image 305, and the original angular resolution of the original image 305 is maintained in the cropped image 315. The cropped image 315 is also referred to as an “un-binned image.”

After these internal representations (i.e. the down-sampled image 310 and the cropped image 315) are computed, the ER system runs its image quality pipeline on both images separately. This pipeline can include any type of enhancement operation, such as a temporal filtering operation, a content enhancement or filtering operation, and so on. Because the down-sampled image 310 is a low-resolution image, the enhancement operations can be performed in a streamlined manner because they are performed on an image that has a much lower resolution as compared to the original image 305. Also, even though the enhancement operations are now performed on two images (e.g., the down-sampled image 310 and the cropped image 315), the embodiments can achieve an overall improvement in efficiency (as compared to performing the enhancement operations on the original image 305) because of the low-resolution of the down-sampled image 310.

In another step, the two images (i.e. the down-sampled image 310 and the cropped image 315) are composed into a single image (i.e. the foveated image 330) that has the same resolution as the original image 305. In this implementation, the foveated image 330 is generated by up-sampling by a factor of 2 (or at least the same sample factor as the down-sampling operation), as shown by up sample 335. The cropped image 315 is then aligned and overlaid (as shown by copy 340) onto the up-sampled version of the image, resulting in the generation of the foveated image 330.

By down-sampling the original image 305 where 2×2 pixels were binned, the number of pixels is reduced by a factor of 4 compared to the resolution of the original image 305. This reduction in pixel count considerably speeds up the compute of the ER system, particularly during the enhancement pipeline, which may involve temporal filtering. At the same time, it is possible to maintain the original high angular resolution in the center (or the foveated portion) of the output image, which is beneficial for other implementations, such as object range detection.

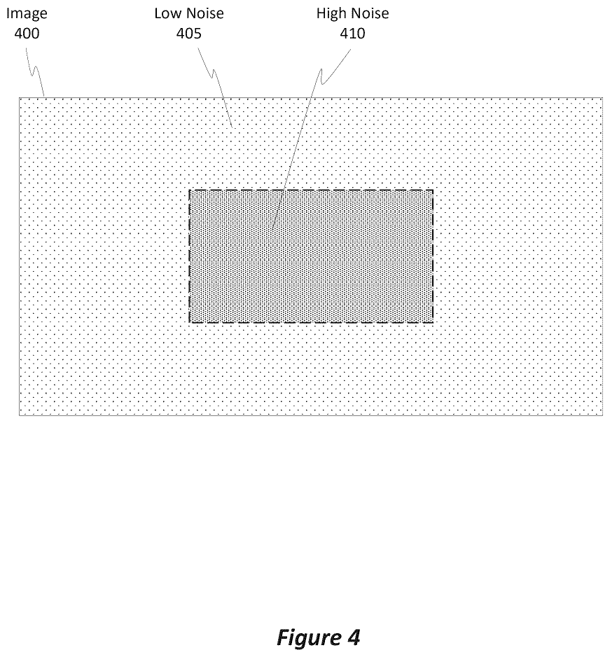

The technique illustrated in FIG. 3 is beneficial in many scenarios, but it can be improved, particularly when practiced in scenarios involving low light levels. For instance, under low light levels, the binned and un-binned images (e.g., down-sampled image 310 and cropped image 315, respectively) have different noise characteristics. This is because the binned image is generated by averaging 2×2 pixels, which leads to lower noise compared to the un-binned image. For well-lit environments, this difference in noise levels is not a problem, but things change as the light level decreases. Under very low light levels (or at least light levels falling below a given threshold), the rectangle in the output image (corresponding to the cropped image 315) that is populated by un-binned pixels becomes very visible and distracting to the user due to the higher amount of noise in that region. The above is true because there is relatively higher temporal fluctuation of intensity values for the pixels inside the rectangle, but intensity fluctuations for pixels outside the rectangle are lower. This phenomenon is visualized in FIG. 4.

In particular, FIG. 4 shows an image 400 that corresponds to the foveated image 330 of FIG. 3 and that is generated using the process flow 300. Notice, there is a stark distinction between the different noise levels, as shown by low noise 405 and high noise 410.

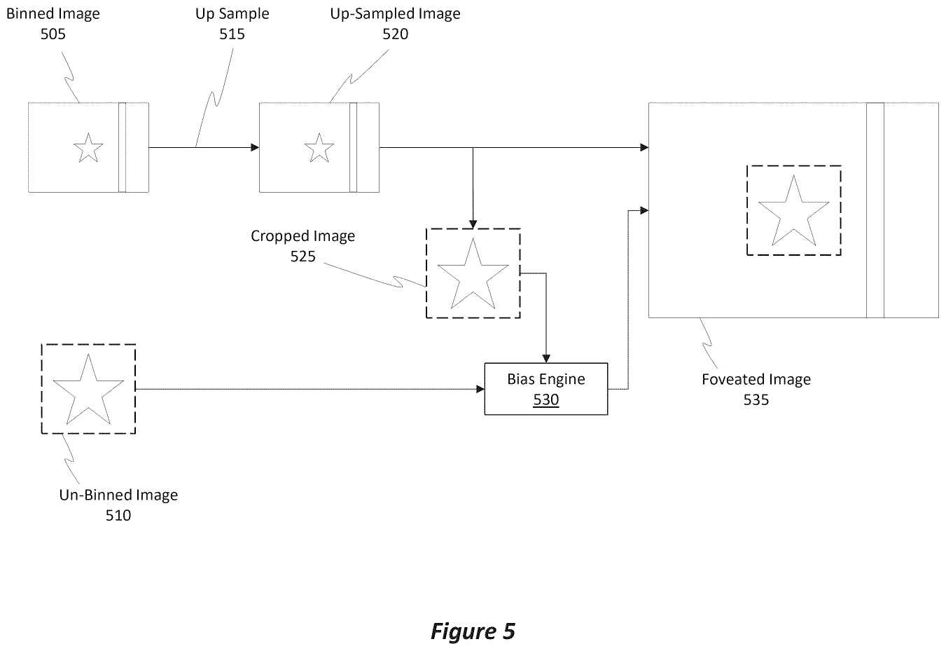

The disclosed embodiments provide various solutions to the above problems. These solutions are illustrated in FIG. 5 by the improved process flow 500 for performing foveated rendering.

In particular, service 105 of FIG. 1 accesses the original image 305 of FIG. 3 and generates the down-sampled image 310 and the cropped image 315 in the same manner as was described with respect to FIG. 3. The binned image 505 is now representative of the down-sampled image 310. Similarly, the un-binned image 510 is now representative of the cropped image 315.

The enhancement pipeline operations may then be performed on the binned image 505 and the un-binned image 510. For instance, temporal filtering, content enhancement, other filtering, or any other enhancement operations can be performed on these two different images. As mentioned earlier, because the binned image 505 is a much lower resolution as compared to the original image, performing the enhancements on these two images results in gains in efficiency as compared to performing the enhancements solely on the original image.

After the enhancement pipeline is performed, service 105 then performs an up-sampling operation (as shown by up sample 515) on the binned image 505 to generate the up-sampled image 520. In contrast to FIG. 3, service 105 subsequently crops the center part (or whatever part is the foveated part) of the up-sampled image 520 to produce the cropped image 525. Note that this cropped image 525 is obtained from the binned image 505 and is therefore less noisy than the un-binned image 510. It should be noted that while many examples recited herein are directed to a scenario where the center portion of the images are the foveated or higher resolution portions, it should be appreciated that any portion of the image can be the foveated portion. It is not necessarily a requirement that the center portion of the image is the foveated portion.

Service 105 then applies a weighted average/image blend operation between the cropped image 525 and the un-binned image 510 via the bias engine 530, which can be implemented as a part of the service 105. That is, service 105 can implement the weighted average/image blend operation. The bias engine 530 is tasked with determining which pixels of one or both of the cropped image 525 and the un-binned image 510 are to be used in an effort to reduce the noise impact while also providing content that meets or exceeds a resolution threshold. Further details on this aspect will be provided shortly. As will be described in more detail later, the bias engine 530 can combine the pixels from the cropped image 525 and the un-binned image 510 in numerous different ways. In some scenarios, the same blending operation is used to generate the entirety of the resulting biased image while in other scenarios, a combination of multiple different blending operations are used to generate the resulting biased image. For instance, a first blending operation may be used to blend pixels for a first region of the resulting biased image while a second, different blending operation may be used to blend pixels for a second region of the resulting biased image. In some scenarios, the central area of the resulting biased image may be generated using a first blending operation while the peripheral areas of the resulting biased image may be generated using a second blending operation. The bias engine 530 can blend pixels in a spatial manner as well as potentially in a temporal manner (e.g., images having different timestamps are blended together). The resulting biased image is then copied and aligned and overlaid onto the up-sampled image 520 to create the foveated image 535.

As mentioned previously, one significant problem with foveated rendering relates to the different noise characteristics that occur under very low light. The output image is populated by un-binned (center part) and binned pixels (periphery). This leads to different noise characteristics. Due to the higher noise, the inner rectangle becomes visible under low light conditions, as was shown in FIG. 4. To combat and address this issue, service 105 is configured to blend the cropped image 525 and the un-binned image 510 in a manner so as to reduce or entirely eliminate the noise differential that exists in the image 400 of FIG. 4.

To do so, service 105 (and in particular the bias engine 530) computes the weighted average for a resultant pixel as:

Weighted Average(binned, un-binned)=w*binned+(1−w)*un-binned

Here, “binned” and “un-binned” are aligned pixels from the input images (i.e. the cropped image 525 and the un-binned image 510, respectively) to the bias engine 530 of FIG. 5. Service 105 is able to set the weight “w” to achieve a proper blend of those two pixels. In at least some embodiments, if there is good light level (i.e. a light level that meets or exceeds a first threshold), service 105 will take advantage of the higher angular resolution of the un-binned image by setting w=0. If the light level is very low (i.e. a light level that is less than a second threshold), service 105 will take advantage of the low noise in the binned image by setting w=1.

It is also desirable to have fractional values between 0 and 1 to ensure a smooth transition between the binned and un-binned images. If service 105 were to directly switch from 0 to 1, this change would be very visible/disturbing to the user. Even worse, if light conditions are such that service 105 is being used in an environment having light levels that are very close to the light level threshold causing the switch, many of these hard transitions might occur. For instance, for one frame, the result might be slightly above the threshold, but for the next frame, the result might be slightly below, and so on.

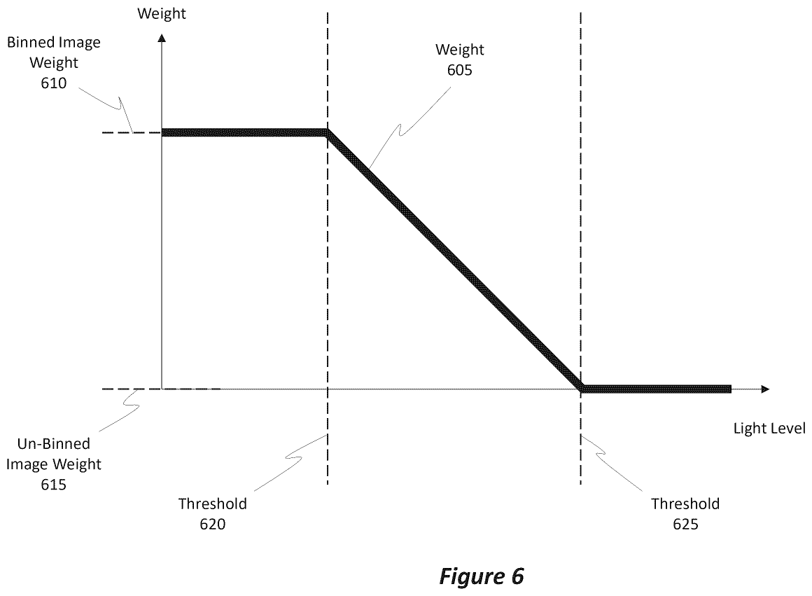

Instead, in at least some implementations, service 105 is configured to compute “w” as a function of light level or, more generally, as a function of noise level. The amount of noise in an image can indicate the quality of that image. This noise level can be a factor in determining which pixels will be extracted from which image. Light level or even the camera's gain setting can operate as a proxy for the noise level in an image. Thus, in at least some embodiments, the functions described herein are performed as a function of noise level. In some implementations, the function is designed to ensure a smooth transition from using the pixels in the un-binned image to using the pixels in the binned image. The transition from using the pixels in the un-binned image to using the pixels in the binned image may occur in a spatial manner and/or a temporal manner. As indicated above, temporal smoothing is beneficial because it avoids hard transitions when the environmental conditions or the conditions reflected by the obtained images are at or near the threshold light or noise values. Spatial smoothing is beneficial because it helps provide a progressive or non-interruptive transition along the X/Y axes of the image. Optionally, different regions of the image may be blended using different blending techniques. As one example, the center portion of the resulting image may involve one biasing or weighting technique while the peripheral portions of the resulting image may involve a different biasing or weighting technique. Optionally, the user's gaze can be a factor in determining which biasing technique will be used for which portion of the image. The area of the image where the user is looking may involve the use of a first biasing technique while the peripheral areas may involve the use of a second biasing technique. An example function is shown in FIG. 6, as shown by the weight function 600.

In FIG. 6, for low light levels, “w” takes a value of 1, which means that the binned image is biased and the pixels from the binned image are used. For high light levels, “w” takes values of 0, which means that the un-binned image is biased and the pixels from the un-binned image are used. There are transition light levels for which the weight “w” is gradually reduced. This ensures a smooth transition when going from binned to un-binned and vice versa. As mentioned earlier, however, light level can be viewed as being a proxy or a sub-factor of the overall factor involving noise levels. For example, a given light level will tend to have a corresponding noise level for many sensor types. Thus, light level can represent one sub-factor of noise. In some implementations, a sensor may directly output an indication of an expected noise or perhaps combinations of other factors (e.g., temperature, humidity, light levels, ambient electromagnetic fields, or any other environmental or sensor condition). These other factors or combinations of other factors may also be included in the calculus of determining which pixels from which image are used during the blending operation.

For instance, FIG. 6 shows a weight function 600 that plots a weight 605 by which pixels from the binned image are used and pixels from the un-binned image are used. For low light levels, the weight 605 takes a value of 1, and the binned image pixels are biased, as shown by binned image weight 610. That is, the foveated portion of the foveated image 535 of FIG. 5 (e.g., the center portion of the foveated image 535) may include pixels obtained exclusively from the cropped image 525 (i.e. a “binned” image). By way of further illustration, when the light levels meet or are less than the first threshold 620, then the weight 605 will bias toward the binned image weight 610.

On the other hand, for high light levels, the weight 605 takes a value of 0, and the un-binned image pixels are biased, as shown by un-binned image weight 615. That is, the foveated portion of the foveated image 535 of FIG. 5 may include pixels obtained exclusively from the un-binned image 510. By way of further illustration, when the light levels meet or exceed the second threshold 625, then the weight 605 will bias toward the un-binned image weight 615.

The weight function 600 shows a progressive change in biasing between the first threshold 620 and the second threshold 625. For instance, as the light levels progressively increase from the first threshold 620 to the second threshold 625, the weight 605 will progressively be more biased toward the un-binned image weight 615.

FIG. 6 shows the weight function 600 as a linear function. One will appreciate, however, how different functions can be used to modify the biasing effect. In some cases, non-linear functions (e.g., curved lines) can be used for the biasing effect. Thus, the depiction shown in FIG. 6 is but one example of how the biasing can be implemented. Another example of a blending function includes temporal blending (e.g., perhaps a weighted average of a certain number of earlier noise levels), as mentioned earlier, spatial blending, or perhaps even graphical blending. Regarding graphical blending, this blending technique can be based on a distance from an edge of the un-binned image or the cropped image or perhaps even the resulting biased image. Different blending functions may be used depending on the X/Y coordinate of the pixel that is being analyzed or perhaps on the distance from the edge of the image or perhaps from the center region of the image.

Service 105 of FIG. 1 can also harness the intelligence of the ML engine 115 to determine how to implement the weight bias function. In some cases, ML engine 115 can be trained based on different light conditions of different environments to determine how the biasing will be implemented. Additionally, ML engine 115 can be trained and later tuned to modify the first threshold 620 and/or the second threshold 625. For instance, depending on the type of environment, the different thresholds can be increased or decreased. As two examples, for a dark, indoor environment that has few windows, the ML engine 115 might set the thresholds to be at a first set of values. For a dark, outdoor environment (e.g., perhaps a full moon outdoor environment), the ML engine 115 might set the thresholds to be at a second set of values that are different than the first set of values. Thus, service 105 can detect the type of environment in which the ER system 110 is operating, and service 105 can employ the use of the ML engine 115 to set the thresholds and to implement a corresponding weight function.

Regarding the noise levels (or perhaps the light levels, camera gain setting, or a different factor), service 105 can determine the noise levels in a variety of ways. In one example scenario, service 105 can determine the noise levels by using a light sensor to determine the ambient light levels of the environment/scene, where the noise level generated by an image sensor correlates to at least the ambient light level. In some examples, the noise level for different types of image sensors (visible, IR, thermal) may differ for a given ambient light level. In another example scenario, service 105 can determine the noise levels indirectly by analyzing the gain setting of the camera(s) that are generating the images (e.g., the original image 305 of FIG. 3). A higher gain setting may indicate a lower light type of environment while a lower gain setting indicates a brighter light type of environment. Thus, different techniques can be used to determine the noise levels generated by of the environment.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

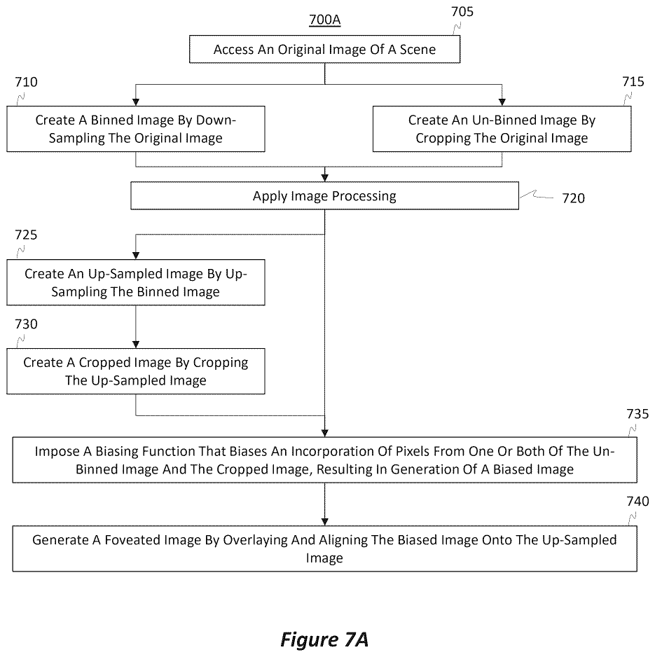

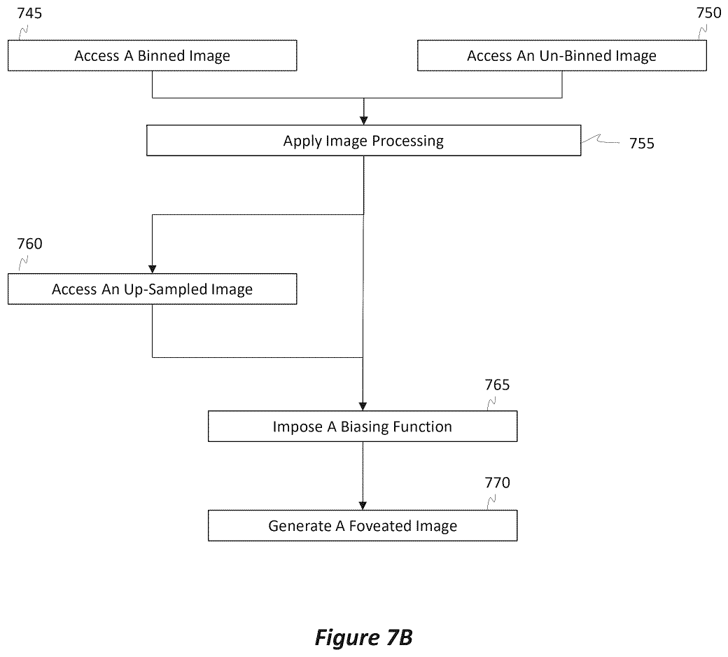

Attention will now be directed to FIG. 7A, which illustrates a flowchart of an example method 700A for generating a foveated image having a reduced noise profile, particularly for a boundary region of the foveated content in the image. Method 700A can be implemented within the computing architecture 100 of FIG. 1. Also, method 700A can be performed by service 105 of FIG. 1.

Method 700A includes an act (act 705) of accessing an original image of a scene. Notably, the original image has an original resolution. In some implementations, the original image is generated by a low light camera. Of course, cameras of other modalities can be used as well to generate the image.

Act 710 includes creating a binned image by down-sampling the original image. The binned image 505 of FIG. 5 is one example of this “binned image.”

The binned image has a first resolution that is lower than the original resolution as a result of the down-sampling operation. The down-sampling operation reduces the original resolution by a first factor to result in the first resolution. In some cases, the first factors can be a 2×2 reduction in pixel count. Preferably, the factors are integral integer values for both X factor and the Y factor. Preferably, the resolution of the un-binned image is an integral multiple of the corresponding factors. The first factor can be set to any value, such as 3×3, 4×4, 5×5, 2×3, 4×2, and so on.

Act 715 includes creating an un-binned image by cropping the original image. The un-binned image 510 of FIG. 5 is representative of this “un-binned image.”

The un-binned image includes first content selected to have a second resolution. In some implementations, the second resolution is the same as the original resolution. The un-binned image includes the content that is desirable to have a higher angular resolution.

In some implementations, the un-binned image is created based on a gaze of a user of the computer or ER system performing method 700A. For instance, the ER system can include or employ eye tracking technology to determine the user's gaze. The area of the display where the user is looking is often the area that should be displayed using higher angular resolution content, or foveated content. Thus, the cropped portion forming the un-binned image can include the content where the user is gazing.

As another option, the un-binned image is not created based on a gaze of a user of the computer or ER system. For instance, in some scenarios, the first content of the un-binned image corresponds to content that is displayable in a center region of a display of the ER system. Thus, instead of relying on eye tracking, some embodiments are configured to crop the center portion of the image and use that portion as the content in the un-binned image. Stated differently, the first content included in the un-binned image may correspond to content displayed at a center region of a display of the computer system. Stated differently, the first content included in the un-binned image may correspond to content included in a center region of the original image.

As another option, the first content included in the un-binned image may correspond to content displayed at a particular region of a display of the computer system, where the particular region is one where a user of the computer system is gazing or will subsequently be gazing based on a predictive gazing analysis. As yet another option, the first content included in the un-binned image may correspond to content displayed at a particular region of a display of the computer system, where the particular region is not a peripheral region of a determined gaze of a user of the computer system, where the gaze is determined using eye tracking.

As another option, pixels included in the first content that is included in the un-binned image are bounded by a quadrilateral shape or border. As such, the cropping is performed by cropping the original image based on the quadrilateral shape. Of course, other shapes can be used, such as elliptical shapes, circular shapes, triangular shapes, pentagons, hexagons, heptagons, octagons, and so on. In some implementations, the cropping is quadrilateral in shape, and a different shape is applied during the bias function. Optionally, the bias function may be hard-coded to focus on a specific region of the image. As another option, the bias function may be implemented in software and may be dynamic in its implementation. In some implementations, a GPU shader or an FPGA can be used to control the various operations, such as by creating the images and/or the biasing function. Symmetrical shapes can be used, and non-symmetrical shapes can be used.

After the binned image and the un-binned image are generated, any number or type of enhancement operations can be performed. For instance, the temporal filtering mentioned earlier can be performed on these two images. Act 720 demonstrates such a scenario. For instance, act 720 includes applying an image processing operation on at least one of the binned image or the un-binned image.

Act 725 includes creating an up-sampled image by up-sampling the binned image. Act 725 is typically performed after the enhancement operations of act 720 are performed.

The up-sampled image has a third resolution. The up-sampling operation increases the lower resolution (i.e. the first resolution) of the binned image 505 up to the third resolution by un-sampling using a second factor to result in the up-sampled image having the original resolution. That is, the third resolution is often the same as the original resolution; though in some implementations, the third resolution might be different than the original resolution.

Act 730 includes creating a cropped image by cropping the up-sampled image. Here, second content included in the cropped image corresponds to the first content in the un-binned image. For instance, with reference to FIG. 5, the cropped image 525 includes the “star” content. Similarly, the un-binned image 510 also includes the “star” content. Thus, the content in both of these images correspond to one another.

Based on a noise parameter of the scene and/or based on a camera parameter (e.g., temperature of the camera, age of the camera, duration of use, etc.), act 735 includes imposing a biasing function that biases an incorporation of pixels from one or both of the un-binned image and the cropped image, resulting in generation of a biased image. The biasing function may be a linear function, or it may be a non-linear function. Any technique can be used to determine the noise parameter. For instance, an ambient light sensor can be used to determine the ambient light of the scene, and the ambient light may be the noise parameter for a given type of sensor. Similarly, the gain value of the camera that generated the original image can be analyzed to infer the ambient light of the scene, and the gain setting can be used to select a value for the noise parameter.

In some cases, the biasing function biases incorporation of pixels from the binned image into the biased image when the noise parameter is less than or equal to a first threshold. Optionally, the biasing function biases incorporation of pixels from the un-binned image into the biased image when the noise parameter meets or exceeds a second threshold. As another option, the biasing function biases incorporation of pixels from both the binned image and the un-binned image into the biased image when the noise parameter is between the first threshold and the second threshold.

Act 740 includes generating a foveated image by overlaying and aligning, or more generally combining, the biased image onto the up-sampled image. Notably, the up-sampled image may include third content that corresponds to the biased image. Here, the biased image can be overlaid on top of and aligned with the third content. By way of example and with reference to FIG. 5, the resulting biased image (i.e. the output from the bias engine 530) may include the “star” content. Similarly, the up-sampled image 520 also includes “star” content. The biased image can be overlaid and aligned with the “star” content in the up-sampled image 520, resulting in generation of the foveated image 535. The foveated image can then be displayed on a display of an extended reality system.

In some implementations, a machine learning engine is trained to determine thresholds used by the biasing function. For instance, the first threshold 620 and the second threshold 625 of FIG. 6 can be determined by the machine learning engine. The incorporation of the pixels from one or both of the un-binned image and the cropped image may be performed by computing a weighted average.

FIG. 7B shows another example method 700B that can be implemented in a manner similar to method 700A. Method 700B includes an act (act 745) of accessing a binned image that is a down-sampled version of an original image. The binned image has a first resolution that is lower than an original resolution of the original image.

Act 750 includes accessing an un-binned image. This un-binned image is either (i) a cropped version of the original image or (ii) the original image. The un-binned image includes first content having a second resolution. In some implementations, the un-binned image is the cropped version of the original image. In other implementations, the original image operates as the un-binned image.

Act 755 includes applying an image processing operation on at least one of the binned image or the un-binned image.

Act 760 includes accessing an up-sampled image. This up-sampled image is an up-sampled version of the binned image, and the up-sampled image has a third resolution. In some implementations, the

Based on (i) a noise parameter, (ii) a light parameter of the scene, or (iii) a camera parameter, act 765 includes imposing a biasing function that biases an incorporation of pixels originating from one or both of the un-binned image and either the up-sampled image or, alternatively, pixels based on corresponding pixels of the binned image, resulting in generation of a biased image. Thus, the biasing operation can involve the intermediate up-sampled image or pixels directly from the binned image at a translated coordinate. When the pixels that are based on the corresponding pixels of the binned image are used, the “corresponding pixels” generally refer to pixels having similar coordinate values (e.g., within a threshold level of similarity) as between the two different images. Optionally, the up-sampled image may be cropped to generate a cropped image. In such scenarios, the biasing function biases the incorporation of pixels from one or both of the un-binned image and the cropped image.

Act 770 includes generating a foveated image by overlaying and aligning the biased image onto the up-sampled image. In some scenarios, the foveated image is generated by overlaying and aligning the biased image onto up-sampled pixels from the binned image.

Method 700B can also generally be described as method of generating a foveated image from an original image. The foveated image may include output pixels for a lower effective resolution portion and output pixels for a higher effective resolution portion.

For instance, for at least the output pixels of the higher effective resolution portion of the output image and where each output pixel having a corresponding coordinate, the method may include imposing a biasing function. This biasing function biases an incorporation of pixels from one or both of: (a) an un-binned pixel corresponding to the coordinate and (b) a binned pixel corresponding to the coordinate. Here, the binned pixel corresponds to the coordinate being a down-sampled pixel of the original image,

For output pixels of the higher effective resolution portion of the foveated image, the biasing function includes incorporation of the un-binned pixels. For output pixels of the lower effective resolution portion of the foveated image, the output pixels do not incorporate the un-binned pixels.

In some implementations, the higher effective resolution portion corresponds to a particular region where a user of a computer system is gazing or is predicted to subsequently be gazing. Optionally, the un-binned pixel is from an un-binned image, and the un-binned image is formed by cropping the original image based on a defined quadrilateral shape. The higher effective resolution portion may be bounded by the quadrilateral shape.

In some cases, the biasing function is based on a parameter. In such cases, the biasing function: biases incorporation of binned pixel when the parameter is less than a first threshold, biases incorporation of un-binned pixel when the parameter is greater than a second threshold, and biases incorporation of both binned pixel and un-binned pixel when the parameter is between the first and second threshold.

The parameter may be based at least in part on (i) a noise parameter, (ii) a light parameter of a scene, or (iii) a camera parameter. Optionally, the biasing function's incorporation of pixels is performed by computing a weighted average.

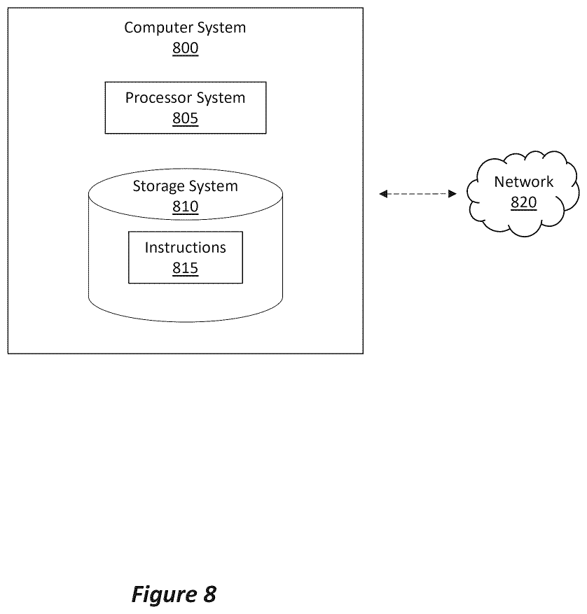

Attention will now be directed to FIG. 8 which illustrates an example computer system 800 that may include and/or be used to perform any of the operations described herein. For instance, computer system can implement service 105 of FIG. 1. Computer system can also take the form of ER system 110.

Computer system 800 may take various different forms. For example, computer system 800 may be embodied as a tablet, a desktop, a laptop, a mobile device, or a standalone device, such as those described throughout this disclosure. Computer system 800 may also be a distributed system that includes one or more connected computing components/devices that are in communication with computer system 800.

In its most basic configuration, computer system 800 includes various different components. FIG. 8 shows that computer system 800 includes a processor system 805, which may include one or more processor(s) (aka a “hardware processing unit”) and a storage system 810.

Regarding the processor(s) of processor system 805, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 800. The different components, modules, engines, and services described herein may be implemented as objects or processors that execute on computer system 800 (e.g. as separate threads).

Storage system 810 may be physical system memory, which may be volatile, non-volatile, or some combination of the two. The term “memory” may also be used herein to refer to non-volatile mass storage such as physical storage media. If computer system 800 is distributed, the processing, memory, and/or storage capability may be distributed as well.

Storage system 810 is shown as including executable instructions 815. The executable instructions 815 represent instructions that are executable by the processor(s) of processor system 805 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 800 may also be connected (via a wired or wireless connection) to external sensors (e.g., one or more remote cameras) or devices via a network 820. For example, computer system 800 can communicate with any number devices or cloud services to obtain or process data. In some cases, network 820 may itself be a cloud network. Furthermore, computer system 800 may also be connected through one or more wired or wireless networks to remote/separate computer systems(s) that are configured to perform any of the processing described with regard to computer system 800.

A “network,” like network 820, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 800 will include one or more communication channels that are used to communicate with the network 820. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
a processor system; and
a storage system that stores instructions that are executable by the processor system to cause the computer system to:
access a binned image that is a down-sampled version of an original image;
access an un-binned image that is either (i) a cropped version of the original image or (ii) the original image, the un-binned image including first content;
apply an image processing operation on at least one of the binned image or the un-binned image;
based on a parameter, impose a biasing function that biases an incorporation of pixels originating from one or both of the un-binned image and pixels based on corresponding pixels of the binned image, resulting in generation of a biased image; and
generate a foveated image by overlaying and aligning the biased image onto up-sampled pixels from the binned image.

2. The computer system of claim 1, wherein the instructions are further executable to cause the computer system to:
access an up-sampled image that is an up-sampled version of the binned image;
create a cropped image by cropping the up-sampled image, wherein second content included in the cropped image corresponds to the first content in the un-binned image,
wherein the cropped image is used during the biasing function, such that the biasing function biases the incorporation of pixels from one or both of the un-binned image and the cropped image, resulting in the generation of the biased image.

3. The computer system of claim 1, wherein the un-binned image is the cropped version of the original image.

4. The computer system of claim 1, wherein the binned image has a first resolution that is lower than an original resolution of the original image, wherein the un-binned image has a second resolution, and wherein the second resolution is the same as the original resolution.

5. The computer system of claim 1, wherein the binned image has a first resolution that is lower than an original resolution of the original image, wherein the un-binned image has a second resolution, wherein an up-sampled image, which is an up-sampled version of the binned image, has a third resolution, and wherein the third resolution is the same as the original resolution.

6. The computer system of claim 1, wherein the first content included in the un-binned image corresponds to content included in a center region of the original image.

7. The computer system of claim 1, wherein the first content included in the un-binned image corresponds to content displayed at a particular region of a display of the computer system, the particular region being one where a user of the computer system is gazing or will subsequently be gazing.

8. The computer system of claim 1, wherein the first content included in the un-binned image corresponds to content displayed at a particular region of a display of the computer system, the particular region not being a peripheral region of a determined gaze of a user of the computer system.

9. The computer system of claim 1, wherein the un-binned image is the cropped version of the original image, the un-binned image being formed by cropping the original image based on a defined quadrilateral shape, and wherein pixels included in the first content that is included in the un-binned image are bounded by the quadrilateral shape.

10. The computer system of claim 1, wherein:
an up-sampled image is accessed, the up-sampled image being an up-sampled version of the binned image,
the biasing function biases incorporation of pixels originating from the up-sampled image into the biased image when the parameter is less than a first threshold,
the biasing function biases incorporation of pixels from the un-binned image into the biased image when the parameter meets or exceeds a second threshold, and
the biasing function biases incorporation of pixels originating from both the up-sampled image and the un-binned image into the biased image when the parameter is between the first threshold and the second threshold.

11. An extended reality (ER) system comprising:
a processor system; and
a storage system that stores instructions that are executable by the processor system to cause the ER system to:
access a binned image that is a down-sampled version of an original image;
access an un-binned image that is either (i) a cropped version of the original image or (ii) the original image, the un-binned image including first content;
based on (i) a noise parameter, (ii) a light parameter, or (iii) a camera parameter, impose a biasing function that biases an incorporation of pixels originating from one or both of the un-binned image and pixels based on corresponding pixels of the binned image, resulting in generation of a biased image; and
generate a foveated image by combining the biased image with pixels based on the binned image.

12. The ER system of claim 11, wherein the biasing function is a linear function.

13. The ER system of claim 11, wherein an up-sampled image is accessed, the up-sampled image being an up-sampled version of the binned image, wherein the up-sampled image includes content that corresponds to the biased image, and wherein the biased image is overlaid on top of and aligned with the content.

14. The ER system of claim 11, wherein the un-binned image is further created based on a gaze of a user of the ER system.

15. The ER system of claim 11, wherein the first content of the un-binned image corresponds to content that is displayable in a center region of a display of the ER system.

16. A method of generating a foveated image from an original image, the foveated image comprising output pixels for a lower effective resolution portion and output pixels for a higher effective resolution portion, the method comprising:
for at least the output pixels of the higher effective resolution portion of the output image, each output pixel having a corresponding coordinate:
impose a biasing function, the biasing function biasing an incorporation of pixels from one or both of:
(a) an un-binned pixel corresponding to the coordinate, and
(b) a binned pixel corresponding to the coordinate, the binned pixel corresponding to the coordinate being a down-sampled pixel of the original image,
wherein:
for output pixels of the higher effective resolution portion of the foveated image, the biasing function including incorporation of the un-binned pixels; and
for output pixels of the lower effective resolution portion of the foveated image, the output pixels not incorporating the un-binned pixels.

17. The method of claim 16, wherein the higher effective resolution portion corresponds to a particular region where a user of a computer system is gazing or is predicted to subsequently be gazing.

18. The method of claim 16, wherein the un-binned pixel is from an un-binned image, the un-binned image being formed by cropping the original image based on a defined quadrilateral shape, and wherein the higher effective resolution portion is bounded by the quadrilateral shape.

19. The method of claim 16, wherein the biasing function is based on a parameter, and wherein the biasing function:
biases incorporation of binned pixel when the parameter is less than a first threshold,
biases incorporation of un-binned pixel when the parameter is greater than a second threshold,
biases incorporation of both binned pixel and un-binned pixel when the parameter is between the first and second threshold.

20. The method of claim 19, wherein the parameter is based at least in part on (i) a noise parameter, (ii) a light parameter of a scene, or (iii) a camera parameter.

21. The method of claim 16, wherein the biasing function's incorporation of pixels is performed by computing a weighted average.
